(19) United States
(12) Patent Application Publication
(10) Pub. No.: US 2022/0261048 A1
(43) Pub. Date: Aug. 18, 2022

(54) ELECTRONIC DEVICE COMPRISING A DISPLAY ANTENNA LAYER

(71) Applicant: Samsung Electronics Co., Ltd., Gyeonggi-do (KR)

(72) Inventors: Jungmin PARK, Gyeonggi-do (KR); Yeonwoo KIM, Gyeonggi-do (KR); Daehee PARK, Gyeonggi-do (KR); Dongil SON, Gyeonggi-do (KR); Janghoon HAN, Gyeonggi-do (KR)

(21) Appl. No.: 17/733,032

(22) Filed: Apr. 29, 2022

Related U.S. Application Data
(63) Continuation of application No. PCT/KR2022/001226, filed on Jan. 24, 2022.

(30) Foreign Application Priority Data
Jan. 25, 2021 (KR) 10-2021-0010092

(51) Int. Cl. G06F 1/16

(52) U.S. Cl. CPC G06F 1/1698; G06F 1/1694

(57) ABSTRACT

An electronic device is provided, which includes a housing including a front surface on which a display glass is formed, a display panel, a display antenna layer, provided inside the housing, between the display glass and the display panel, and configured to transmit and receive a communication signal, a wireless communication module electrically connected to the display antenna layer, a grip sensor configured to detect a change in capacitance of the display antenna layer based on an approach of an external object, and a processor configured to receive a signal from the grip sensor and adjust a transmission energy of the display antenna layer, based on the received signal from the grip sensor.

### CROSS-REFERENCE TO RELATED APPLICATIONS

This application is a bypass continuation of international Application No. PCT/KR2022/001226, which was filed on Jan. 24, 2022, and is based on and claims priority to Korean Patent Application No. 10-2021-0010092, which was filed in the Korean Intellectual Property Office on Jan. 25, 2021, the entire disclosure of each of which is incorporated herein by reference.

### BACKGROUND

### 1. Field

This disclosure relates generally to an electronic device including a display antenna layer and, more particularly, to an electronic device including a display antenna layer and a grip sensor.

### 2. Description of Related Art

Development of wireless communication technology has led to widespread use of electronic devices using wireless communication. In addition, the demand for wireless data traffic has increased since the commercialization of 4th generation (4G) communication systems, and as such, there is a demand for next-generation communication systems achieving higher data rates.

In response thereto, a 5th generation (5G) communication system for transmitting and/or receiving signals using high frequency bands (e.g., 3 GHz to 300 GHz), e.g., a millimeter wave (mmWave) band, has been developed. A 5G communication system may transmit and receive a wireless signal using a high frequency band, overcome a high free space loss due to a frequency characteristic, and have an efficient arrangement structure for increasing the gain of the antenna. Accordingly, the development of an antenna module for use in a 5G communication system is underway.

For example, an antenna of an electronic device may include an array type antenna module in which a plurality of antenna elements are arranged at regular intervals, and a beam pattern may be formed in any one direction inside the electronic device. The antenna module may be arranged such that a beam pattern is formed toward at least a portion, the back, and/or a side of the front surface in an interior space of the electronic device.

An electromagnetic wave absorption rate refers to a level of absorbing electromagnetic waves generated from the electronic device into a human body, and the electromagnetic wave absorption rate of the high frequency band is specified as a maximum power exposure (MPE) unit or a power density (PD) unit. In each country, a reference value of the electromagnetic wave absorption rate is specified, so the conventional electronic device is used in a range satisfying a PD specification by reducing the transmission energy.

When an electronic device; includes an antenna transmitting and receiving a communication signals using a high frequency band, a plurality of antenna modules may occupy a wide area in various directions in order to secure the antenna gain, and in this example, the PD value should be reduced collectively to satisfy the PD specification. However, in satisfying the PD specification, the communication performance of the electronic device may be deteriorated.

### SUMMARY

The disclosure has been made to address the above-mentioned problems and disadvantages, and to provide at least the advantages described below.

An aspect of the disclosure it to provide an electronic device including a display antenna layer having a structure that satisfies a PD specification, while maintaining improved communication performance.

In accordance with an aspect of the disclosure, an electronic device is provided, which includes a housing including a front surface on which a display glass is formed, a display panel, a display antenna layer, provided inside the housing, between the display glass and the display panel, and configured to transmit and receive a communication signal, a wireless communication module electrically connected to the display antenna layer, a grip sensor configured to detect a change in capacitance of the display antenna layer based on an approach of an external object, and a processor configured to receive a signal from the grip sensor and adjust a transmission energy of the display antenna layer, based on the received signal from the grip sensor.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an electronic device in a network environment according to an embodiment;

FIG. 2 illustrates a display module of an electronic device according to an embodiment;

FIG. 3 illustrates an antenna module of an electronic device according to an embodiment;

FIG. 4A illustrates a front surface of an electronic device according to an embodiment;

FIG. 4B illustrates an exploded view of an electronic device according to an embodiment;

FIG. 4C illustrates a cross section of the electronic device of FIG. 4A, as seen from A-A′, according to an embodiment;

FIG. 5 is a graph illustrating a distance of an electronic device and a PD value according to an embodiment;

FIG. 6 illustrates a display antenna layer of an electronic device according to an embodiment;

FIG. 7 illustrates a region of a display antenna layer according to an embodiment;

FIG. 8A illustrates a grip sensor pad of a display antenna layer according to an embodiment;

FIG. 8B illustrates a grip sensor pad of a display antenna layer according to an embodiment;

FIG. 8C illustrates a grip sensor pad of a display antenna layer according to an embodiment;

FIG. 8D illustrates a grip sensor pad of a display antenna layer according to an embodiment;

FIG. 9A illustrates a coupling structure of a display antenna, layer according to an embodiment;

FIG. 9B illustrates a coupling structure of a display antenna layer according to an embodiment;

FIG. 9C illustrates a coupling structure of a display antenna layer according to an embodiment;

FIG. 10 illustrates a second antenna array of an electronic device according to an embodiment;

FIG. 11A is a graph illustrating an antenna gain according to a horizontal wave of a second antenna array according to an embodiment; and

FIG. 11B is a graph illustrating an antenna gain according to a horizontal rave of a second antenna array according to an embodiment.

### DETAILED DESCRIPTION

Various embodiments of the disclosure are described below with reference to the accompanying drawings. In the following description, specific details such as detailed configuration and components are merely provided to assist the overall understanding of these embodiments. Therefore, it should be apparent to those skilled in the art that various changes and modifications of the embodiments described herein can be made without departing from the scope and spirit of the disclosure. In addition, descriptions of well-known functions and constructions are omitted for clarity and conciseness.

More specifically, the disclosure is not limited to the embodiments described hereinafter, but also includes various modifications, equivalents, and/or alternatives of the embodiments of the disclosure.

In relation to explanation of the drawings, similar drawing reference numerals may be used for similar constituent elements.

The singular forms of the noun corresponding to the item may include one or more of the items unless explicitly indicated otherwise. In the disclosure, each of the phrases “A or B”, “at least one of A and B”, and “at least one of A or B”, “A, B, or C”, “at least one of A, B, and C” or “at least one of A, B, or C” ma include any one of the items listed along with a corresponding one of the phrases, or any possible combination thereof.

The terms “first,” “second,” or may simply be used to distinguish the corresponding components from other corresponding components, and are not limited in other aspects (e.g., importance or order). When a component (e.g., first) is “coupled” or “connected” to as another (e.g., a second) component with or without the term “functionally” or “communicatively”, it means that any component may be connected directly to the other component directly (e.g., by wire), wirelessly, or via a third component.

The term “module”, as used in various embodiments of the disclosure, may include a unit implemented in hardware, software, or firmware, and may be used interchangeably with terms such as, for example, logic, logic blocks, components, or circuitry. The module may be a minimum unit of the component, or a portion thereof, that performs one or more functions. For example, according to one embodiment, a module may be implemented in the form of an application-specific integrated circuit (ASIC).

The various embodiments of the disclosure may be implemented with software including one or more instructions stored in the storage medium readable by a machine (e.g., electronic device). For example, the processor of a device (e.g., electronic device) may call at least one instruction among one or more instructions stored in the storage medium and execute the instructions. This allows a device to be operated to perform at least one function according to the called at least one instructions. The instructions may include a code generated by a compiler or executed by an interpreter. The storage medium readable by a machine may be provided in the form of a non-transitory storage medium, where “non-temporary” means that the storage medium is a tangible device and does not include a signal (e.g., electromagnetic wave). This term does not distinguish that data is permanently or temporarily stored in the storage medium.

A method according to one or more embodiments may be provided included a computer program product. The computer program product may be exchanged between a seller and a purchaser as a commodity. The computer program product may be distributed in the form of a machine-readable storage medium (e.g., a compact disc read only memory (CD-ROM)), or distributed (e.g., download or upload) online directly among at least two user devices (e.g., smartphones) through an application store (e.g., PlayStore™). In the case of online distribution, at least a portion of the computer program product (e.g., downloadable app) may be at least stored temporarily in a storage medium such as a server of a manufacturer, a server of an application store, or a memory of a relay server, or temporarily generated.

According to an embodiment, each component (e.g., a module or program) of the components described above may include a single or a plurality of entities, some of the plurality of entities may be separately arranged in other components. According to various embodiments, one or more of the aforementioned components or operations may be omitted, or one or more other components or operations may be added. Alternatively or additionally, some elements (e.g., modules or programs) may be integrated into one entity to perform the same or similar functions performed by each respective element prior to integration. Operations performed by a module, program, or other element, in accordance with various embodiments, may be performed sequentially, in a parallel, repetitive, or heuristically manner, or at least some operations may be performed in a different order, or at least one other operations may be added.

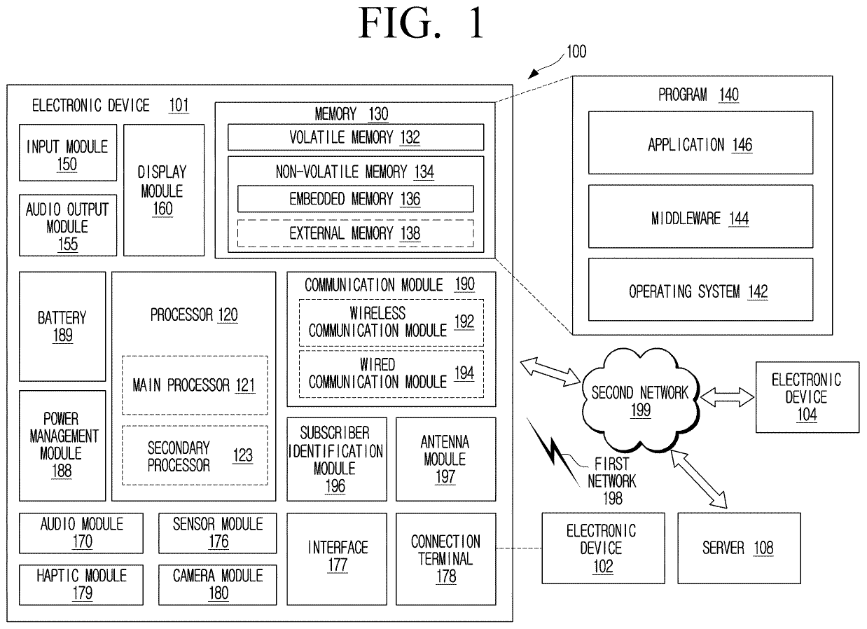

FIG. 1 illustrates an electronic device in a network environment according to an embodiment.

Referring to FIG. 1, in a network environment 100, an electronic device 101 may communicate with an electronic device 102 through a first network 198 (e.g., a short-range wireless communication network) or communicate with at least one of an electronic device 104 or a server 108 through a second network 199 (e.g., wide area network), The electronic device 101 may communicate with the electronic device 104 through the server 108, The electronic device 101 may include a processor 120, a memory 130, an input device 150, an audio output module 155, a display module 160, an audio module 170, a sensor module 176, an interface 177, a connection terminal 178, a haptic module 179, a camera module 180, a power management module 188, a battery 189, a communication module 190, a subscriber identification module 196, or an antenna module 197. In some embodiments, at least one (e.g., connection terminal 178) of these components may be omitted from electronic device 101, or one or more other components may be added. In some embodiments, some of these components (e.g., a sensor module 176, camera module 180, or antenna module 197) may be implemented as a single component (e.g., display module 160).

The processor 120, for example, may execute software (e.g., program 140) to control at least one other component (e.g., hardware or software component) of the electronic device 101 coupled to the processor 120, and may perform various data processing or operations. According to an embodiment, as at least a part of the data processing or operation, the processor 120 may store the command or data received from another component (e.g., the sensor module 176 or the communication module 190) to a volatile memory 132, process command or data stored in the volatile memory 132, and store the result data in a non-volatile memory 134. The processor 120 may include a main processor 121 (e.g., a central processing unit (CPU) or an application processor (AP)), or a secondary processor 123 (e.g., a graphics processing unit (GPU), a neural processing unit (NPU), an image signal processor (ISP), a sensor hub processor, or a communication processor (CP)) which may be operated together or independently. For example, if the electronic device 101 includes the main processor 121 and the secondary processor 123, the secondary processor 123 may be configured to use lower power than the main processor 121, or to be specialized for a specified function. The secondary processor 123 may be implemented separately from, or as a part of, the main processor 121.

The secondary processor 123 may, for example, in place of the main processor 121 while the main processor 121 is in a deactivated state (e.g., a sleep state) or along with the main processor 121 while the main processor 121 is in an active state (for example: execution of an application) control a part of the functions or states related to at least one component (e.g., the display module 160, the sensor module 176, or the communication module 190) among the components of the electronic device 101. The secondary processor 123 (e.g., an ISP or a CP) may be implemented as a part of a functionally related other components (e.g., camera module 180 or communication module 190), The secondary-processor 123 (e.g., a neural network processing device) may include a hardware structure specialized for processing an artificial intelligence (AI) model. The AI model may be generated through machine learning Such learning may be performed, for example, by the electronic device 101 in which an AI model is performed, or may be performed through a separate server (e.g., server 108). The learning algorithms may include, but are not limited to, supervised learning, unsupervised learning, semi-supervised learning, or reinforcement learning. The AI model may include a plurality of artificial neural network layers. The artificial neural network may be, but is not limited to, a deep neural network (DNN), a convolutional neural network (CNN), a recurrent neural network (RNN), a restricted Boltzmann machine, a deep belief network (DBN), a bi-directional recurrent DNN (BRDNN), deep Q-networks, or a combination of two or more thereof. The AI model may additionally or alternatively include a software structure, in addition to the hardware structure.

The memory 130 may store various data used by at least one component (e.g., processor 120 or sensor module 176) of the electronic device 101. The data may include, for example, software (e.g., program 140) and input data or output data related with software instructions. The memory 130 may include the volatile memory 132 or non-volatile memory 134.

The processor 120 may be stored in the memory 130 as software, and include, for example, an operating system 142, middleware 144, or an application 146.

The input module 150 may receive a command or data to be used for the components (e.g., processor 120) of the electronic device 101 from the outside (e.g., user) of the electronic device 101. The input module 150 may include, for example, a microphone, a mouse, a keyboard, a key (e.g., button), or digital pen (e.g., stylus pen).

The sound output module 155 may output a sound signal to the outside of the electronic device 101. The sound output module 155 may include, for example, a speaker or a receiver. The speaker may be used for general purposes, such as multimedia playback or recording playback, and the receiver may be used to receive incoming calls. The receiver may be implemented separately from, or as a part of, the speaker.

The display module 160 may visually provide information to an outside (e.g., user) of the electronic device 101. The display module 160 may include a display, a hologram device, a projector, or a control circuit for controlling the device. The display module 160 may include a touch sensor 251 which is set to detect a touch or a pressure sensor which is set to measure intensity of power generated by the touch.

The audio module 170 may convert sound into an electric signal, or convert an electric signal to sound. The audio module 170 may acquire sound through the input module 150, or output sound through the sound output module 155, or an external electronic device (e.g., electronic device 102) (e.g., speaker or headphone) which is directly or wirelessly connected to the electronic device 101.

The sensor module 176 may detect the operation state of the electronic device 101 (e.g., power or temperature), or an external environment state (e.g., a user state), and generate an electrical signal or a data value corresponding to the detected state. The sensor module 176 may include a gesture sensor, a gyro sensor, an atmospheric pressure sensor, a magnetic sensor, an acceleration sensor, a grip sensor, a proximity sensor, a color sensor, an infrared (IR) sensor, a bio sensor, a temperature sensor, a humidity sensor, or an illuminance sensor.

The interface 177 may support one or more designated protocols so that the electronic device 101 is directly or wirelessly connected to an external electronic device (e.g., the electronic device 102), The interface 177 may include a high definition multimedia interface (IMMI), a universal serial bus (USB) interface, a secure digital (SD) card interface, or an audio interface.

The connection terminal 178 may include a connector through which the electronic device 101 may be physically connected to an external electronic device (e.g., the electronic device 102). The connection terminal 178 may include an HDMI connector, a USB connector, an SD card connector, or an audio connector (e.g., a headphone connector).

The haptic module 179 may convert an electrical signal into a mechanical stimulus (e.g., vibration or motion) or an electrical stimulus that a user may recognize through a tactile or kinesthetic sense. The haptic module 179 may include a motor, a piezoelectric element, or an electric stimulation device.

The camera module 180 may photograph a still image or a moving image. The camera module 180 may include one or more lenses, image sensors, ISPs, or flashes.

The power management module 188 may manage power supplied to the electronic device 101, The power management module 188 may be implemented as at least a part of power management integrated circuit (PMIC).

The battery 189 may supply power to at least one component of the electronic device 101. The battery 189 may include a non-rechargeable primary battery, a rechargeable auxiliary battery, or a fuel cell.

The communication module 190 may support establishment of direct (e.g., a wired) communication channel between the electronic device 101 and an external electronic device (e.g., electronic device 102, electronic device 104, or server 108) or wireless communication channel, and communication through the established communication channels. The communication module 190 may include one or more CPs which are operated independently of the processor 120 (e.g., an AP) and support direct (e.g., wired) communication or wireless communication. The communication module 190 may include a wireless communication module 192 (e.g., cellular communication module, near field wireless communication module, or global navigation satellite system (GLASS) communication module) or a wired communication module 194 (e.g., a local area network (LAN) communication module, or a power line communication module). The corresponding communication module among these communication modules may communicate with an external electronic device through the first network 198 (e.g., Bluetooth™, Wifi direct or near field communication (NFC) network such as IR data association (IrDA)) or the second network 199 (e.g., a telecommunication network such as a legacy cellular network, a 5G network, a next generation communication network, the Internet, or a computer network (e.g., a LAN or a WAN)). These types of communication modules may be incorporated into one component (e.g., a single chip) or implemented with a plurality of components (e.g., a plurality of chips) that are separate from each other. The wireless communication module 192 may confirm or authenticate the electronic device 101 in the communication network such as the first network 198 or the second network 199 using the subscriber information (e.g., international mobile subscriber identity (IMSI)) stored in the subscriber identification module 196.

The wireless communication module 192 may support a 5G network and a next generation communication technology, e.g., new radio (NR) access technology after a 4G network. The NR connection technology may support high-capacity data high-speed transmission (enhanced mobile broadband (eMBB)), terminal power minimization, massive machine type communications (mMTC), or ultra-reliable and low-latency communications (URLLC). The wireless communication module 192 may support a high frequency band (e.g., an mmWave band), for example, to achieve a high data transmission rate. The wireless communication module 192 may support technologies such as various technologies for securing performance in a high frequency band, e.g., beamforming, massive multiple-input and multiple-output (MIMO), full dimensional MIMO (FD-MIMO), array antenna, analog beam-forming, or large scale antenna. The wireless communication module 192 may support various requirements defined in the electronic device 101, the external electronic device (e.g., the electronic device 104) or the network system (e.g., the second network 199). The wireless communication module 192 may support a peak data rate (e.g., at least 20 Gbps) for realizing an eMBB, a loss coverage (e.g., 164 dB or less) for mMTC implementation, or a U-plane latency (e.g., downlink (DL) and uplink (UL) by 0.5 ins or below, respectively, or round trip 1 ms or below) for URLLC implementation.

The antenna module 197 may transmit a signal or power to an external device (e.g., an external electronic device) or receive a signal or power from the outside. The antenna module 197 may include one or more antennas (e.g., array antenna), and at least one antenna suitable for a communication method used in a communication network, such as the first network 198 or the second network 199, may be selected by the communication module 190 from the plurality of antennas.

The antenna module 197 may include a plurality of antennas (e.g., an array antenna), or may include an antenna comprising a conductor made of a conductor or conductive pattern formed over a substrate (e.g., a printed circuit board (PCB)).

The antenna module 197 may form an mmWave antenna module. The mmWave antenna module may include a PCB, a radio frequency integrated circuit (RFIC) disposed on or adjacent to a first surface (e.g., a bottom surface) of the PCB, and capable of supporting a designated high frequency band (e.g., an mmWave band), and a plurality of antennas (e.g., an array antenna) disposed adjacent to or adjacent to a second surface (e.g., top surface or side) of the PCB and capable of transmitting or receiving a signal of the designated high frequency band.

The signal or power may be transmitted or received between the communication module 190 and an external electronic device through at least one antenna. According to some embodiments, other components (e.g., an RFIC) other than the radiator may be further formed as part of the antenna module 197.

At least a part of the components may be interconnected through the communication method a bus, a general purpose input and output (GPIO), a serial peripheral interface (SPI), or a mobile industry processor interface (MIPI)) among peripheral devices and exchange a signal (e.g., command or data) from each other.

The command or data may be transmitted or received between the electronic device 101 and the external electronic device 104 through the server 108 connected to the second network 199. Each of the electronic devices 102 and 104 may be devices which are the same or different types from the electronic device 101. All or a part of the operations executed by the electronic device 101 may be executed by one or more external devices among the external electronic devices 102, 104, or 108. For example, when the electronic device 101 has to perform a function or service automatically, or in response to a request from a user or another device, the electronic device 101 may request one or more external electronic devices to perform at least a part of the function or the service instead of, or in addition to, performing the function or service by itself. The one or more external electronic devices that have received the request may execute at least a portion of the requested function or service, or an additional function or service associated with the request, and transmit the result of the execution to the electronic device 101. The electronic device 101 may process the result as is or additionally, and provide the result as at least a portion of the response to the request. For this purpose, for example, cloud computing, distributed computing, mobile edge computing (MEC) or client-server computing technology may be used. The electronic device 101 may provide ultra-low latency services using distributed computing or MEC, In another embodiment, the external electronic device 104 may include an Internet of things (IoT) device. The server 108 may be an intelligent server using machine learning and/or neural networks. The external electronic device 104 or server 108 may be included in a second network 199. The electronic device 101 may be applied to an intelligent service (e.g., a smart home, a smart city, a smart car, or health care) on the basis of 5G communication teleology and IoT-related technology.

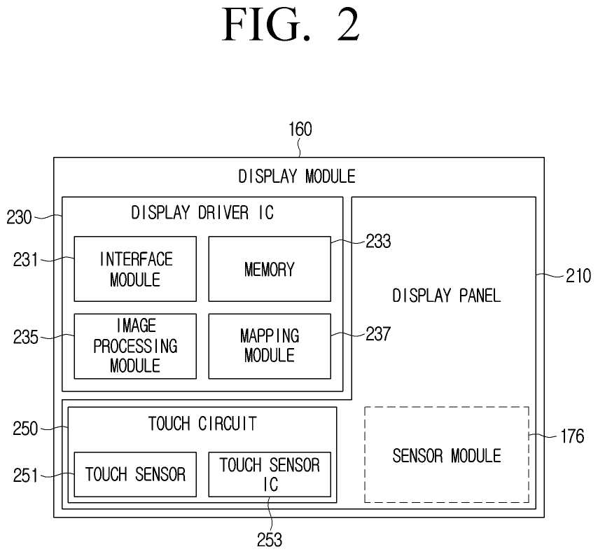

FIG. 2 illustrates a display module of an electronic device according to an embodiment.

Referring to FIG. 2, the display module 160 includes a display panel 210 and a display driver integrated circuit (IC) 230 for controlling the same.

The display driver IC 230 includes an interface module 231, a memory 233 (e.g., a buffer memory), an image processing module 235, and a mapping module 237. The display driver IC 230 may receive image information including image data, or an image control signal corresponding to a command for controlling the image data from another component of the electronic apparatus 101 through the interface module 231. The image information may be received from the processor 120 (e.g., an AP) or the secondary processor 123 (e.g., a GPU) operating independently of the function of the main processor 121.

The display driver IC 230 may communicate with the touch circuit 250 or the sensor module 176 through the interface module 231. The display driver IC 230 may store at least a portion of the received image information in the memory 233, e.g., in a frame unit. The image processing module 235 may perform pre-processing or post-processing (e.g., resolution, brightness, or size adjustment) for at least a part of the image data based on at least one of the characteristics of the image data or characteristics of the display panel 210. The mapping module 237 may generate a voltage value or a current value corresponding to the image data pre-processed or post-processed through the image processing module 235. The generation of a voltage value or current value may be performed based at least in part on an attribute of pixels of the display panel 210 (e.g., an array of pixels (RGB stripe or PenTile structure), or a size of each of the subpixels). At least some pixels of the display panel 210 may be driven based at least in part on the voltage value or current value such that visual information (e.g., text, an image, or an icon) corresponding to the image data may be displayed through the display panel 210.

The display module 160 further includes a touch circuit 250. The touch circuit 250 includes a touch sensor 251 and a touch sensor IC 253 for controlling the same. The touch sensor IC 253 may control the touch sensor 251 to detect a touch input or hovering input for the designated position of the display panel 210. The touch sensor IC 253 may detect a touch input or hovering input by measuring the change in the signal (e.g., voltage, light amount, resistance, or charge) for the designated position of the display panel 210. The touch sensor IC 253 may provide information about the detected touch input or hovering input (e.g., location, area, pressure, or time) to the processor 120. At least part of the touch circuit 250 (e.g., the touch sensor IC 253) may be included as part of the display driver IC 230, or as part of the display panel 210, or other components placed outside of the display module 160.

The display module 160 may further include at least one sensor of the sensor module 176 (e.g., a fingerprint sensor, an iris sensor, a pressure sensor, or an illumination sensor), or may further include a control circuit. At least one sensor or the control circuit thereof may be embedded in a portion of the display module 160 (e.g., the display panel 210 or the display driver IC 230) or a portion of the touch circuit 250. For example, when the sensor module 176 embedded in the display module 160 includes a biometric sensor (e.g., a fingerprint sensor), the biometric sensor may obtain biometric information (e.g., a fingerprint image) associated with the touch input through some area of the display panel 210. As another example, when the sensor module 176 embedded in the display module 160 includes a pressure sensor, the pressure sensor may obtain pressure information associated with the touch input through a portion or the entire area of the display panel 210. The touch sensor 251 or the sensor module 176 may be placed between pixels of the pixel layer of the display panel 210, or above or below the pixel layer.

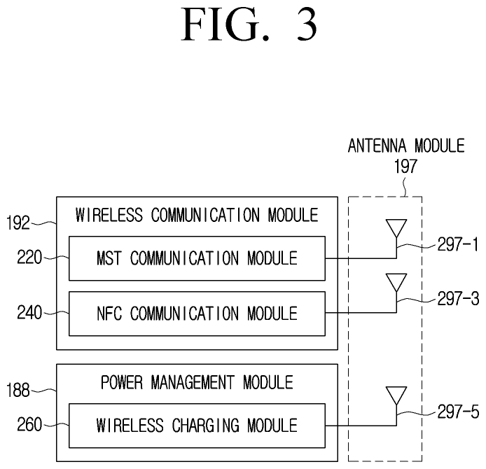

FIG. 3 illustrates an antenna module of an electronic device according to an embodiment.

Referring to FIG. 3, a wireless communication module 192 includes a magnetic secure transmission (MST) communication module 220 and an NFC module 240, and a power management module 188 includes a wireless charging module 260, An antenna module 297 includes a plurality of antennas including an MST antenna 2974 connected to the MST communication module 220, an NFC antenna 297-3 connected to the NFC communication module 240, and a wireless charging antenna 297-5 connected to the wireless charging module 260.

The MST communication module 220 may receive a signal including payment information, such as control information, or card information, from a processor, generate a magnetic signal corresponding to the received signal through the MST antenna 2974, and may transmit the generated magnetic signal to an external electronic device (e.g., a point of sale (POS) device).

In order to generate the magnetic signal, the MST communication module 220 may include a switching module including one or more switches coupled to the MST antenna 297-1, and control the switching module to change the direction of the voltage or current supplied to the MST antenna 297-1 in accordance with the received signal. The change in the direction of the voltage or current allows the direction of the magnetic signal (e.g., the magnetic field) transmitted through the MST antenna 297-1 to change accordingly.

When the magnetic signal in a state of which direction is changed, is sensed by the external electronic device, a magnetic card corresponding to the received signal (e.g., card information) may cause a similar effect (e.g., a waveform) to a magnetic field as the magnetic card corresponding to the received signal (e.g., card information) is swiped by the card reader of the electronic device. Payment-related information and control signals received in the form of the magnetic signal in the electronic device may be transmitted, for example, to an external server (e.g., a payment server) through the network.

The NFC communication module 240 may obtain a signal including payment information, such as control information, or card information, from the processor, and transmit the obtained signal to the external electronic device 102 through the NFC antenna 297-3. The NFC communication module 240 may receive such a signal transmitted from the external electronic device through the NFC antenna 297-3.

The wireless charging module 260 may wirelessly transmit power to the external electronic device (e.g., a mobile phone or a wearable device) through the wireless charging antenna 297-5, or may wirelessly receive power from the external electronic device (e.g., a wireless charging device). The wireless charging module 260 may support one or more of a variety of wireless charging methods, e.g., a magnetic resonance method or a magnetic induction method.

Some of the antennas such as the MST antenna 297-1, the NFC antenna 297-3, or the wireless charging antenna 297-5 may share at least a portion of the radiation with each other. For example, the radiation of the MST antenna 297-1 may be used as a radiating portion of the NFC antenna 297-3 or the wireless charging antenna 297-5, and vice versa. The antenna, module 297 may include a switching circuit configured to selectively connect (e.g., close) or separate (e.g., open) at least a portion of the antennas 297-1, 297-3, or 297-5 under the control of the wireless communication module 192 (e.g., the MST communication module 220 or the NFC communication module 240) or the power management module 188 (e.g., the wireless charging module 260). For example, when the electronic device uses a wireless charging function, the NFC communication module 240 or the wireless charging module 260 may control the switching circuit to temporarily separate at least a portion of the radiating portion shared by the NFC antenna 297-3 and the wireless charging antenna 297-5 and connect with the wireless charging antenna 297-5.

At least one function of the MST communication module 220, the NFC communication module 240, or the wireless charging module 260 may be controlled by an external processor. A designated function (e.g., a payment function) of the MST communication module 220 or the NEC communication module 240 may be performed in a trusted execution environment (TEE). The TEE may form an execution environment in which at least some designated areas of the memory are allocated for use in performing functions (e.g., financial transactions or personal information-related functions) requiring relatively high level of security. An approach to the designated area may be allowed in a limited manner, e.g., by classifying according to a subject approaching the area or an application executed in the TEE.

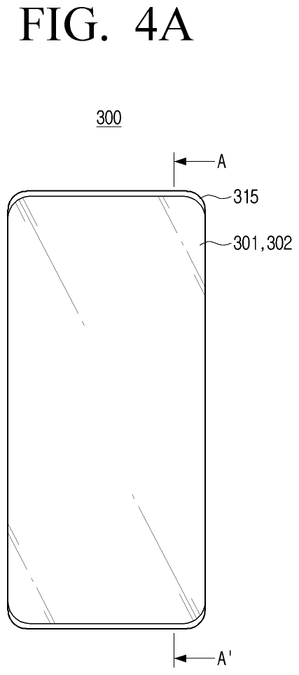

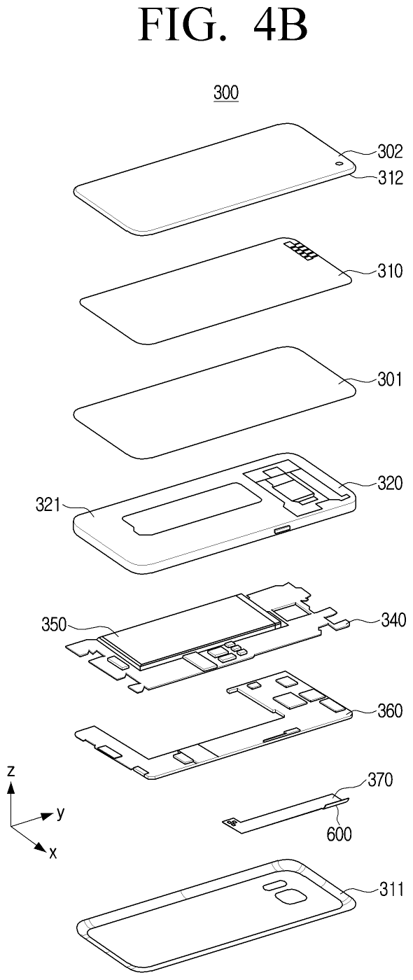

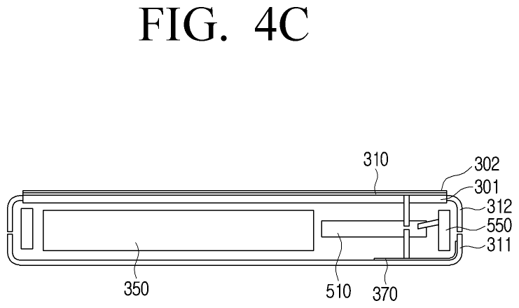

FIG. 4A illustrates a front surface of an electronic device according to an embodiment.

Referring to FIG. 4A, an electronic device 300 includes a housing 315 and a display panel 301.

The housing 315 may form the exterior of the electronic device 300 and may protect components disposed within the housing 315. The housing 315 may include a front plate that protects the front surface of the electronic device 300 and is coupled with the display glass 302, a rear plate that protects the rear surface of the electronic device 300, and a side housing that protects a side surface between the front plate and the rear plate.

The front plate of the housing 315 may be coupled to a substantially transparent display glass 302 or coupled to the display panel 301. The display glass 302 may transmit an image displayed by the display panel 301 disposed on the rear surface. The display glass 302 may transmit a touch signal of a user to the touch sensor of the display panel 301, and may protect the internal components of the electronic device 300 including the display panel 301. The display glass 302 may be composed of a glass plate or polymer plate including various coating layers.

The display panel 301 may include a liquid crystal display (LCD), a light emitting diode (LED), an organic LED (MED), or a micro LED (μLED). For example, the display panel 301 composed of micro LED devices is one of the flat panel display panels 301, and is composed of a plurality of inorganic LEDs each of which is less than or equal to 100 micrometers, so that the micro LED display panel 301 may provide better contrast, response time, and energy efficiency compared to an LCD panel in which the backlight is disposed.

The display panel 301 includes a plurality of through-wiring members formed to prevent a thin film transistor (TFT) substrate from being exposed to the side surface of the TFT substrate, thereby reducing an inactive area and increasing an active area to make the display panel 301 bezel-less, and increasing the layout density of the light emitting device with respect to the display panel 301.

The display panel 301 for implementing a bezel-less format may provide an electronic device 300 including a plurality of display panels 301 capable of increasing an active area when a plurality of displays are connected. Each display panel 301 may be formed to maintain a pitch between pixels of the display panel 301 adjacent to each other with a pitch between each of the pixels in the single display panel 301 as the inactive area is minimized. Accordingly, it is possible to reduce a seam at a connecting portion between each of the display panels 301.

The front surface of the electronic device 300 may also include a camera, a sensor for sensing an operating state of the inside or an environment state of the outside the electronic device 300, an acoustic output device, and an input device such as a microphone key input device.

FIG. 4B illustrates an electronic device according to an embodiment.

Referring to FIG. 4B, the electronic device 300 includes a front plate 312, a side housing 320, a first support member 321, a front plate 312, a display panel 301, a display antenna layer 310, a PCB 340, a battery 350, a second support member 360, an antenna 370, and a rear plate 311.

The display antenna layer 310 may be disposed between the display glass 302 and the display panel 301.

The side housing 320 and the first support member 321 may be coupled to one surface of the display panel 301, and the PCB 340 may be coupled to the other surface. The first support member 321 may be disposed inside the electronic device 300 to be connected to the side housing 320 or may be integrally formed with the side housing 320. The PCB 340 includes a main PCB that controls the overall operation of the electronic device 300, and a processor, a memory, and/or an interface may be mounted.

The battery 350 may power at least one component of the electronic device 300 and may include a primary battery that cannot be recharged, a rechargeable secondary battery, and/or a fuel cell.

At least a portion of the battery 350 may be disposed in the substantially the same plane flush with the PCB 340. The battery 350 may be integrally disposed within the electronic device 300 and may be detachably disposed with the electronic device 300.

The second support member 360 may be coupled to the PCB 340 including the processor and the battery 350, and may support the PCB 340 and the battery 350 to be stably fixed to the rear plate 311 of the housing 315. The second support member 360 may electrically connect the PCB 340 to the antenna 370 and other components, and may include a coupling member and an additional PCB 340 structure.

The antenna 370 may transmit and receive a communication signal. The antenna 370 includes a second antenna array 600 and may be disposed between the rear plate 311 and the battery 350. The antenna 370 may communicate with an external device through the second antenna array 600 or wirelessly transmit and receive power required for charging.

FIG. 4C illustrates a cross section of the electronic device of FIG. 4A, as seen from A-A′, according to an embodiment.

Referring to FIG. 4C, the display antenna layer 310 and the antenna 370 are disposed on the front surface and the rear surface of the electronic device 300, respectively.

The display antenna layer 310 may be disposed between the display glass 302 and the display panel 301, transmit and receive a communication signal in the front direction of the electronic device 300, and the antenna 370 may be disposed between a processor and the rear plate 311, and transmit and receive a communication signal in the rear and lateral directions of the electronic device 300. The processor may receive a wireless communication signal from the display antenna layer 310 and the antenna and provide the signal to the wireless communication module 550.

The wireless communication module 550 may include a CP that supports network communication. More specifically, the wireless communication module 550 may include a first CP for performing wireless communication with 2^{nd} generation (2G), 3^{rd} generation (3G), 4G, or long term evolution (LIE) networks, and/or a second CP for performing wireless communication with a network of a 5G GHz or a mmWave area, which is an ultra-high frequency domain.

The wireless communication module 550 may establish a communication channel of a band to be used in a wireless signal with an external network through the CP, and support legacy network communication through the established communication channel. The first CP and the second CP of the wireless communication module 550 may be implemented in a single chip or a single package to be connected to the processor, and alternatively, a processor, an auxiliary processor, or a communication module may be formed in a single chip or a single package.

Alternatively, the wireless communication module 550 may include at least one of the display antenna layer 310 or the antenna 370 implemented as a PCB. The wireless communication module 550 may transmit a wireless communication signal to the main PCB 510, and a chip or package structure for performing a role of the wireless communication module 550, i.e., transmitting and receiving a wireless communication signal, i.e., a wireless communication signal, may be implemented through the main PCB 510.

An electronic device including the wireless communication module 550 that performs wireless communication with a network of a high frequency domain is applied with an array antenna technology to compensate for the straight feature and path loss, which is the propagation characteristic of the mmWave band. For example, the electronic device may include a plurality of antenna modules for transmitting and receiving signals in various directions, and may secure an antenna gain by adjusting an antenna according to a desired band.

An electronic device according to an embodiment may secure the antenna gain in the direction of the display panel 301 in the transmission and reception of the communication signal in the high frequency domain through the display antenna layer 310 including at least one first antenna array, which is radiated in the direction of the display panel 301 and includes at least one first antenna array. For example, in an electronic device which becomes smaller, an antenna array arrangement in a physically wide area may be secured. According to another embodiment of the disclosure, the electronic device may transmit and receive signals in various directions through a second antenna array that transmits and receives communication signals in a rear surface and a lateral direction, and may reduce path loss and secure antenna gain.

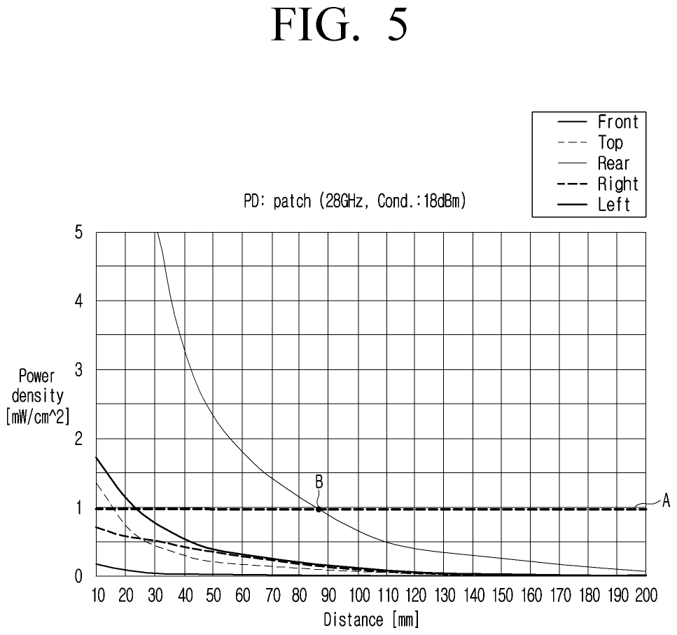

FIG. 5 is a graph illustrating a PD value according to a distance of an electronic device according to an embodiment. More specifically, FIG. 5 illustrates an exemplary graph of a magnitude of power per unit area in an electronic device for transmitting and receiving a communication signal of a high frequency millimeter wave (mmWave) area.

Referring to FIG. 5, the X-axis in the horizontal direction is indicated by a vertical distance [mm] in a specific direction with the electronic device, and the Y-axis in the vertical direction is indicated by measuring a PD value in units of [mW/cm²], The PD value is measured according to the vertical distance of the front, top, rear, right and left sides with the electronic device.

The A line parallel to the X-axis, in FIG. 5, indicates a PD value of about 1 [mW/cm²] as a reference line, and indicates a numerical value that may be affected by a high-frequency communication signal transmission/reception when the user is adjacent to the electronic device. However, the numerical value and A line of FIG. 5 are exemplary for the description of the antenna arrangement and grip sensing area of the disclosure, and in the electronic device, the PD values may be measured differently, and the PD value of the A line may be different.

According to an embodiment, an electronic device may include an antenna array that transmits and receives communication signals in a high frequency domain and occupies a wide area in various directions to reduce antenna loss. The PD value rapidly increase in a position adjacent to the electronic device, and by way of an example of the A line of FIG. 5, the PD value may rapidly increase at a distance of about 8 to 9 mm ire which the B point is located from the rear surface of the electronic device.

Therefore, the electronic device may detect the approaching or contacting of an external object (e.g., a human body) by a predetermined distance or more through a grip sensor or may adjust the maximum power of the communication signal received and transmitted. Accordingly, the PD value of the electromagnetic wave in which the electromagnetic wave generated by the electronic device may influence human body may be controlled.

A grip sensor may sense that an external object is in proximity or contact with the electronic device. More specifically, the grip sensor may detect or sense a change in capacitance that changes by an external object in proximity or contact to provide to a processor. The processor may receive a signal from the grip sensor and adjust the transmission energy of a first antenna array to a second antenna array, when the external object approaches a predetermined distance or more (e.g., a [mm] distance where point B of FIG. 5 is located).

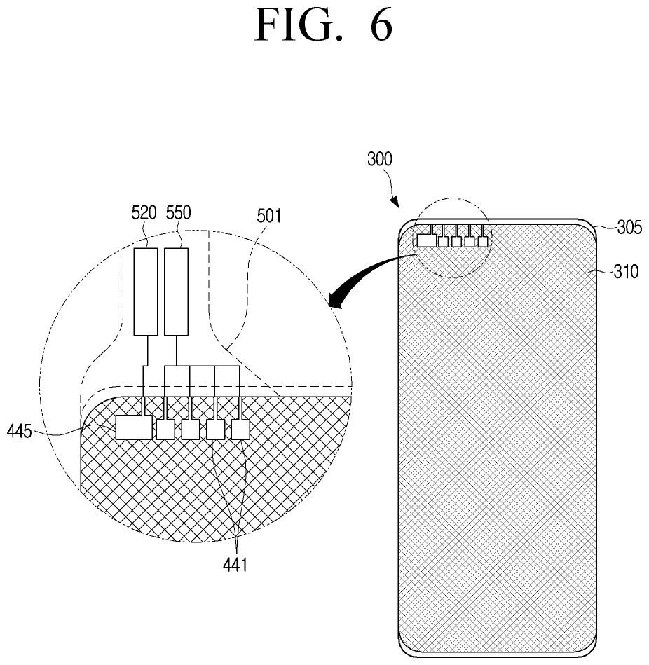

FIG. 6 illustrates a display antenna layer of an electronic device according to an embodiment.

Referring to FIG. 6, a display antenna layer 310 of an electronic device 300 includes a first antenna array 441 and a grip sensor pad 445. Although FIG. 6 illustrates the display antenna layer 310 through a display glass 302 of a housing 315, it is merely a representation for convenience of description. In an actual implementation, the display antenna layer 310 may be implemented to be transparent and may transmit a display image of a display panel 301 disposed on the rear surface to the display glass 302.

The display antenna layer 310 may be provided inside the housing 315 to transmit and receive a communication signal, and may be a radiator made of a conductor or a conductive pattern. The display antenna layer 310 may be made of a thin film conductor, a conductor wire, a metal mesh, or a conductive material.

The display antenna layer 310 may have a radiation pattern radiated in a direction parallel to the display panel 301, and at least a portion of the display antenna layer 310 may have an open mesh structure in which at least a portion is opened. The display antenna layer 310 may include a filler of which at least a portion is filled in an open area of the mesh, thereby transmitting a display screen of the display panel 301. The transparent filler may be made of an adhesive material, and the display antenna layer 310 may be formed of a transparent film.

The display antenna layer 310 may include a first conductive region for transmitting and receiving a communication signal, and a second conductive region of which capacitance varies by the access of an external object. The first and second conductive regions may be electrically connected (or fed) to the processor via the first antenna array 441 or the grip sensor pad 445, the first antenna array 441 may sense a wireless communication signal, and the grip sensor pad 445 may sense the proximity of the object to provide a sensing value.

The first antenna array 441 may be connected to the first conductive region of the display antenna layer 310 to receive a communication signal transmitted and received by the display antenna layer 310, and the wireless communication module 550 may be electrically connected to the first antenna array 441 of the display antenna layer 310 to transmit and receive a communication signal

A plurality of first antenna arrays 441 may be provided. The display antenna layer 310 may be implemented in an array antenna manner in order to increase the antenna gain, and each of the plurality of first antenna arrays 441 may be connected to the first conductive region to transmit a communication signal to perform multiple input and output of the communication signal. The plurality of first antenna arrays 441 may be distantly arranged in a row on one side of the display antenna layer 310.

The grip sensor pad 445 may be an electrode for sensing an access signal, the grip sensor pad 445 may be electrically connected to the second conductive region 420, and the grip sensor 520 may be electrically connected to the second conductive region of the grip sensor pad 445 of the display antenna layer 310 to detect a change in the capacitance of the second conductive region due to the approach of the external object.

The grip sensor pad 445 may be implemented as an independent conductive pad. The grip sensor pad 445 may detect (sense or confirm) a change in capacitance that varies by an external object in proximity or in contact. The grip sensor pad 445 may provide a sensing result to the grip sensor 520 (or a grip sensor circuit).

The grip sensor pad 445 may be disposed on a side of the first antenna array 441 and may be spaced apart from the first antenna array 441 on one side of the display antenna layer 310, or according to an embodiment including an edge display, the first antenna array 441 and the grip sensor pad 445 may be disposed in the edge display area. The first antenna array 441 and the grip sensor pad 445 may be disposed on a side surface of the display antenna layer 310 to reduce image quality deterioration and touch sensitivity deterioration of the display panel 301.

The first antenna array 441 and the grip sensor pad 445 may be connected to the grip sensor 520 and the wireless communication module 550 through a coupling board 501 in which at least a portion is made of a curved flexible PCB (FPCB). In FIG. 6, although the coupling board 501 extends upward for convenience of description, at least a portion of the lower end of the coupling board 501 may be curved and positioned inside the electronic device 300 when the coupling board 501 is actually implemented. The grip sensor 520 and the wireless communication module 550 may be disposed on the coupling board 501, or may be connected to the display antenna layer 310 with the coupling board 501 as an intermediate connector.

The grip sensor 520 may generate a detected signal (hereinafter, a “sensing result”) and transmit the detected signal to the processor. According to an embodiment, the grip sensor 520 may have varied capacitance sensed according to the type of the external object. For example, the grip sensor 520 may sense a change amount of different capacitances with respect to a human body, a wireless charging device, or an external object, and provide the sensing result to the processor, so that the processor may control the transmission energy of the first antenna array 441 and second antenna array according to the received sensing result.

The grip sensor 520 may periodically detect capacitance, and in this example, the grip sensor 520 may have an activated state and a deactivated state depending on whether the capacitance is detected. In addition, the grip sensor 520 may detect capacitance in real time without having a deactivated state. For example, the grip sensor 520 may set an activated state and a deactivated state based on whether the electronic device 300 is being used by a user, or a usage pattern of the user, and a sleep pattern.

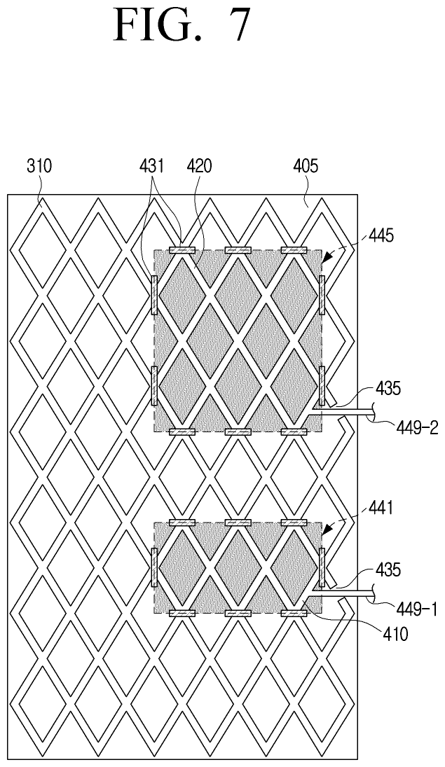

FIG. 7 illustrates a region of a display antenna layer according to an embodiment.

Referring to FIG. 7, a portion of the display antenna layer 310 is enlarged, and the display antenna layer 310 includes a filler 405, a first conductive region 410, a second conductive region 420, a feeding portion 449, and a plurality of segmental portions 431 and 435.

The display antenna layer 310 includes the first conductive region 410 for transmitting and receiving a communication signal and the second conductive region 420 having a variable capacitance by the approach of an external object, and the display antenna layer 310 may be disposed to overlap the entire region of the display panel 301 or to overlap at least a portion of the display panel 301.

The first antenna array 441 includes the first conductive region 410 formed by dividing a portion of the conductive region of the display antenna layer 310 by the segmental portions 431 and 435 so as to be electrically connected to a wireless communication module through the feeding portion 449-1, and the grip sensor pad 445 includes the second conductive region 420 formed by dividing a portion of the conductive region of the display antenna layer 310 by the segmental portions 431 and 435 so as to be electrically connected through a grip sensor and the feeding portion 449-2. The mesh-shaped radiation pattern of the display antenna layer 310 may be segmented by the segmental portions 431 and 435, and the segmented regions may be separated independently within the display antenna layer 310 so that each may operate as an antenna patch.

The first conductive region 410 may be connected to the feeding portion 449-1 of the first antenna array 441 for feeding, the feeding portion 449-1 is electrically connected to the wireless communication module, the second conductive area 420 is electrically connected to the feeding portion 449-2 of the grip sensor pad 445 for feeding, and the display antenna layer 310 may be electrically connected to the processor, the wireless communication module, or the grip sensor.

The display antenna, layer 310 includes the segmental portions 431 and 435 that electrically separate the first conductive region 410 and the second conductive region 420. For example, the first conductive region 410 and the second conductive region 420 may each be composed of an independent antenna element, or an antenna array made of one body may be segmented by segmental portions 431 and 435. The segmental portions 431 and 435 may include a segment by a segmented slit 431 and a segment of a gap 435, and may be implemented in various ways to optimize the radiation performance of the first antenna array 441 and the capacitance for proximity recognition of the second conductive region 420 in the display antenna layer 310.

In FIG. 7, the grip sensor pad 445 has a larger area than the first antenna array 441, but the embodiment is not limited thereto, and the size of the segmented first conductive region 410 and the second conductive region 420 may vary, and the size and shape of the first antenna array 441 and the grip sensor pad 445 may be variously implemented according to the arrangement of the segmental portions 431 and 435.

The display antenna layer 310 may be segmented by the gap 435. The gap 435 may be implemented by a mold structure upon injection of a mold of the display antenna layer 310, or may physically separate and electrically insulate some of the conductive regions forming one body of the display antenna layer 310 through an additional process. The filler 405 may be filled in a region where the gap 435 is formed.

The display antenna layer 310 may be segmented by the segmental slit 431. The segmental slit 431 may be made of a non-conductive material, e.g., a polymer member. The segmental slit 431 may be attached to a portion of the first display antenna layer 310 and may electrically segment a portion and another portion. For example, the segmental slit 431 may be implemented through an insulating material during an injection process using a mold in the manufacture of the display antenna, layer 310.

Through the segmental slit 431 and the gap 435, the display antenna layer 310 may be formed such that the first conductive region 410 or the second conductive region 420 is electrically insulated from another region, and the first conductive region 410 may be utilized as a wireless communication antenna, and the second conductive region 420 may be utilized as a grip sensor antenna. The display antenna layer 310 may transmit and receive a communication signal in the front direction of the electronic device through the first conductive region 410, and sense whether an external object approaches or contacts the front direction of the electronic device through the second conductive region 420. For example, the second conductive region 420 may be an antenna operable as an electrode for sensing a signal by the grip sensor.

In FIG. 7, where the display antenna layer 310 is segmented by the segmental portion 431 and the gap 435, the display antenna layer 310 includes the first conductive region 410 and the second conductive region 420 to perform the respective functions, but the segment structure in the actual implementation of the display antenna layer 310 may vary without being limited to the illustrated example.

The display antenna layer 310 may also include a connection member to electrically connect a portion of the segmented conductive region to another region, or may include a third conductive region by an additional segment unit. The third conductive region may be used as an NFC antenna or a wireless charging antenna according to a purpose of use.

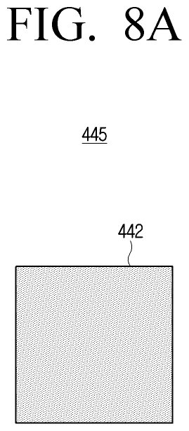

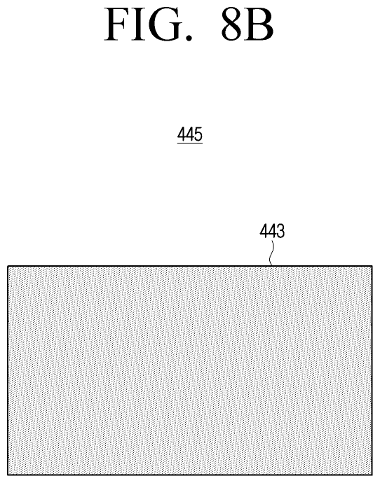

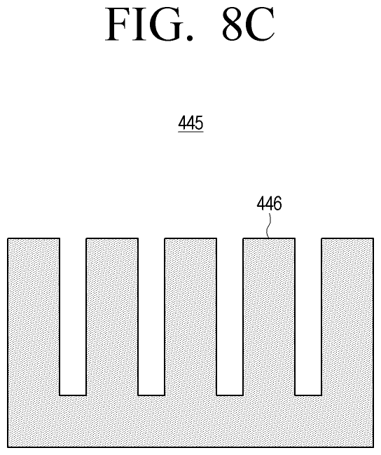

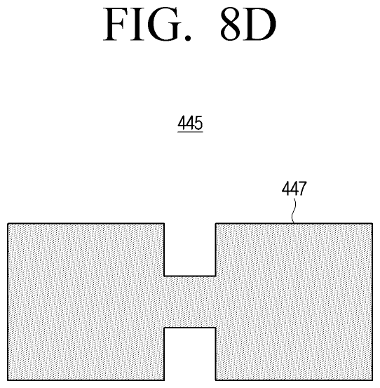

FIGS. 8A to 8D are diagrams illustrating grip sensor pads of a display antenna layer according to embodiments.

Referring to FIGS. 8A-8D, a grip sensor pad 445 of the display antenna layer may have various shapes and forms. For example, as illustrated in FIG. 7, the shape of the grip sensor pad 445 may be designed by the arrangement of the segmental portions 431 and the gaps 435 of the conductive region within the display antenna layer 310.

The grip sensor pad 445 may be overlapped in a direction parallel with the display panel 301 in the display antenna layer 310, and the size and shape of the grip sensor pad 445 may be diverse.

A plurality of touch sensors of the display panel may be spaced apart from each other at predetermined intervals. The size and shape of the pad may include various embodiments so as to correspond to the size and interval of the touch sensor. Although various alternative embodiments of the grip sensor pad 445 have been described based on a square as a structure of the grip sensor pad 445, the grip sensor pad 445 may be circular or polygonal, and may be implemented in various ways to improve touch sensitivity.

Referring to FIG. 8A, the grip sensor pad 445 includes a pad 442 having a square shape.

Referring to FIG. 8B, the grip sensor pad 445 includes a pad 443 having a rectangular shape.

For example, if the size of the touch sensor is equal to or similar to the size of the grip sensor pad 445, the grip sensor pad 445 may not significantly affect the touch sensitivity of the touch sensor, even if implemented in the square shape 442 or the rectangular shape 443.

When a plurality of first antenna arrays are present and multiple input/output is performed, the first antenna array may be implemented in a polygonal or circular structure having a smaller size than the touch sensor and may be spaced apart from each other at a predetermined interval, thereby improving touch sensitivity.

Referring to FIGS. 8C and 8D, the grip sensor pad 445 includes a pad 446 or 447 having a structure in which at least a portion is open. For example, the grip sensor pad 445 may have an area greater than or equal to a predetermined area of area to sense proximity or contact of an external object.

In consideration of the predetermined area of the grip sensor pad 445 and the size and interval of the touch sensor, the shape of the grip sensor pad 445 may have a structure in which at least a portion of the grip sensor pad 145 is opened, and the degradation of the touch function may be reduced through the open space, and the visibility of the display panel may be improved. For example, in the pads 446 and 447 having at least partially opened structures, two facing sides may be formed to be longer than other two sides in consideration of the length ratio of the display panel of the electronic device, and may be designed such that the touch sensitivity may be improved by opening a part of the touch sensor in consideration of the size of the touch sensor.

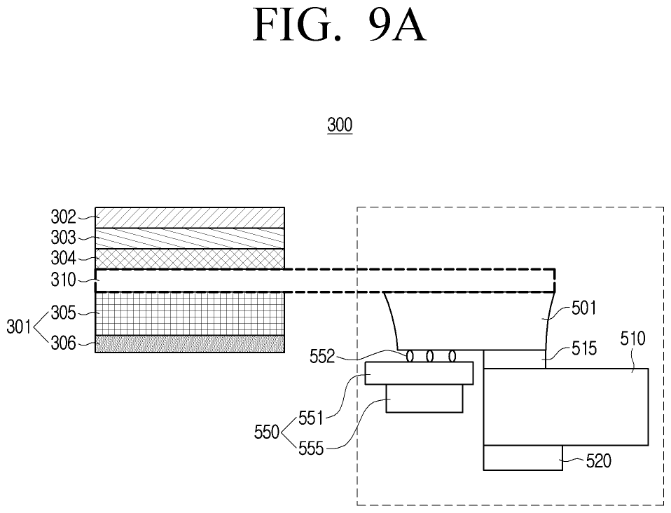

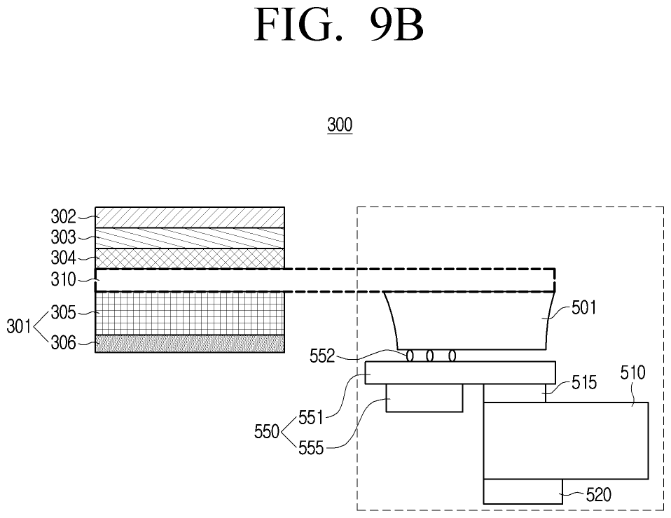

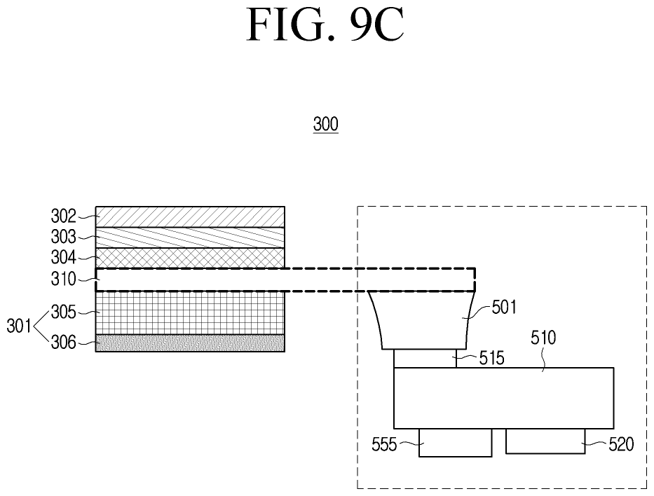

FIGS. 9A to 9C illustrate coupling structures of a display antenna layer according to embodiments.

Referring to FIGS. 9A to 9C, the electronic device 300 includes an optical adhesive film 303, a polarizing film 304, and a display panel 301 including a display substrate 305 and a cover panel 306.

The optical adhesive film 303 may be disposed between the display glass 302 and the polarizing film 304, When the optical adhesive film 303 is adhered to the display glass 302 and cured, the optical adhesive film 303 may be implemented as an optical clear adhesive (OCA) film (e.g., double-sided tape for adhesion) having a high light transmittance.

The polarizing film 304 may be disposed between the optical adhesive film 303 and a display antenna layer 310, The polarizing film 304 may polarize light entering from the outside, pass light vibrating along a designated trajectory, and block light that does not coincide with the designated trajectory. The polarizing film 304 may reduce interference with the displayed image on the display panel 301 caused by reflection of external light which enters after passing through the display glass 302.

The display panel 301 includes the display substrate 305 and the cover panel 306. The display substrate 305 may include a TFT formed in a form of a TFT circuit and a plurality of light emitting elements coupled to the upper surface of the TFT. The TFT layer may be a driving circuit layer in which a driving circuit of the light emitting device is implemented in the form of a TFT circuit. In another embodiment, a power supply circuit, a data driving unit, a gate driving unit, or a timing controller for controlling each driving driver may be disposed on the rear surface of the TFT layer.

The cover panel 306 may be a film layer that protects the display substrate 305 and may reduce the display substrate 305 from colliding with the configuration inside the electronic device 300.

The display antenna layer 310 may be disposed between the display panel 301 and the display glass 302, and may be implemented as an antenna film that is adhered between the polarizing film 304 and the display substrate 305 of the display panel 301.

The display antenna, layer 310 may be connected to the wireless communication module 550 and the processor 120 through a coupling board 501 including an FPCB of which at least a portion is curved. Although the coupling board 501 is illustrated as an intermediate connector in FIGS. 9A to 9C, the embodiments are not limited thereto, and the coupling board 501 may be composed of the wireless communication module 550 and a main PCB 510 as one body.

The wireless communication module 550 for transmitting and receiving a signal in a high frequency band includes at least one of an mmW PCB 551, an mmW circuit 555, an mmWave communication RFIC, or a transceiver. The processor may be implemented as a main PCB 510, and may include the connector 515. The grip sensor 520 may be coupled to the main PCB 510.

As illustrated in FIG. 9A, the display antenna layer 310 may be connected to the mmW circuit 555 through the mmW PCB 551, and may also be connected to the grip sensor 520 through the main PCB 510. More specifically, the first antenna array 441 may be connected to the mmW PCB 551 to transmit a wireless communication signal, and the grip sensor pad 445 may be connected to the connector 515 to transmit a sensing value to the main PCB 510.

Since a wireless communication signal may be directly transmitted from the display antenna layer 310 to the wireless communication module 550 through the coupling board. 501, the path loss may be reduced, and the antenna gain may be increased.

The grip sensor 520 may receive the sensing value from the display antenna layer 310 to sense whether the external object approaches or contacts, and provides a sensing result to the main PCB 510. When the proximity or contact of the external object is detected, the main PCB 510 may control the maximum power of the display antenna layer 3:1.0 to satisfy a PD standard or an PIPE standard.

As illustrated in FIG. 9B, the display antenna layer 310 may be connected to the mmW circuit 555 and the main PCB 510 through the mmW PCB 551, and may be connected from the main PCB module 510 to the grip sensor 520. More specifically, the first antenna array 441 and the grip sensor pad 445 may be connected to the mmW PCB 551 to transmit a wireless communication signal and a sensing value, and the mmW PCB 551 may transmit the wireless communication signal to the mmW circuit 555, and the transmit the sensing value to the grip sensor 520 through the main PCB 510.

For example, a wireless communication signal may be directly transmitted from the display antenna layer 310 to the wireless communication module 550, and thus, the path loss may be reduced and the antenna gain may be increased.

The wireless communication module 550 may include a bonding unit 552 disposed between the display antenna layer 310 and the wireless communication module 550 to bond the display antenna layer 310. For example, the bonding unit 552 may include at least one of lead (Ph), tin (Sn), silver (Ag), copper (Cu), and/or bismuth (Bi). Since the main PCB 510 is directly connected to the mmW PCB 551, the maximum power of the display antenna layer 310 may be controlled via the wireless communication module 550 according to the sensing result of the grip sensor 520.

As illustrated in FIG. 9C, the display antenna layer 310 may be connected to the main PCB 510 through the coupling board 501, and the mmW circuit 555 and the grip sensor 520 may be coupled to the main PCB 0.510. More specifically, the first antenna array 441 and the grip sensor pad 445 may be connected to the main PCB 510 through the connection portion 515 to transmit the wireless communication signal and the sensing value, and the main PCB 0.510 may transmit the wireless communication signal to the mmW circuit 555, and the sensing value may be transmitted to the grip sensor 520. The maximum power of the display antenna layer 310 may be controlled by the mmW circuit 555 and the grip sensor 520 coupled to the main PCB 510, and the main PCB 510 may function as the wireless communication module 550, without including a separate mmW PCB 551.

The above-described arrangement structure is an example of the combination structure of the display antenna layer 310, the wireless communication module 550, and the grip sensor 520 according to various embodiments, but the embodiments are not limited thereto in actual implementation. For example, another structure may be utilized in which a wireless communication signal and a sensing value are, transmitted from the display antenna layer 310 to the wireless communication module 550 and the grip sensor 520, and the maximum power of the display antenna layer 310 is controlled by the processor. The coupling structure and control of the display antenna layer 310 may be applied to a combination and control of the second antenna array 600.

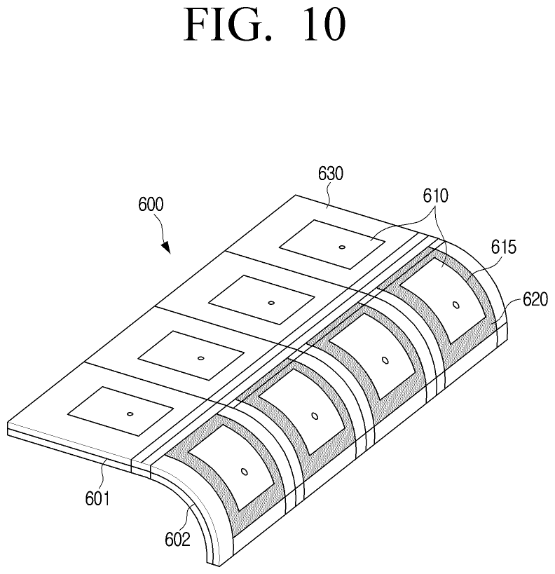

FIG. 10 illustrates a second antenna array of an electronic device according to an embodiment.

Referring to FIG. 10, a second antenna array 600 may be an FPCB 630 including antenna elements 610 and a sensor pad 620.

The second antenna array 600 may be formed on one side of an antenna provided on a rear surface of a display panel, and may be electrically connected to a wireless communication module to transmit and receive a communication signal. The second antenna array 600 may also be electrically connected to a grip sensor to transmit a sensing result by a change in capacitance.

An electronic device may include at least one of a display antenna layer and the second antenna array 600, or may include both a first antenna array and the second antenna array 600. For example, the first antenna array of the display antenna layer may transmit and receive wireless communication signals in a front direction of the electronic device, i.e., in a Z-axis direction from of FIG. 4B, and sense whether an external object approaches or contacts in the front direction, and the second antenna array 600 may transmit and receive wireless communication signals in the rear direction of the electronic device, and sense whether an external object approaches or contacts the rear direction of the electronic device.

The second antenna array 600 may include the FPCB 630 in which at least a portion of the second antenna array 600 is curved. The second antenna array 600 includes a first region 601 parallel to the display panel and a second region 602 of which at least a portion is curved and extended from the first area 601 in the direction of the display panel. In this example, the first region 601 may transmit and receive the wireless communication signal in a direction opposite to the front direction described above with respect to the Z-axis in the rear direction of the electronic device, i.e., in the XYZ orientation direction of FIG. 4B, and the second region 602 may transmit and receive the wireless communication signal in the lateral direction of the electronic device, i.e., the X-axis or the Y-axis or the XY plane direction in the XYZ direction of FIG. 4B, and detect whether an external object approaches or contacts.

The second antenna array 600 may be disposed between a processor and a rear plate of a housing, and the second region 602 may be located adjacent one side of the rear plate. Therefore, in an electronic device including a display antenna layer and the second antenna array 600, a wireless communication signal may be transmitted and received in the front, rear, and lateral directions of the electronic device, and may also detect whether an external object approaches or contacts.

The second antenna array 600 includes a plurality of antenna elements 610, a sensor pad 620, and an insulating surface 615. The plurality of antenna elements 610 may be spaced apart from one side of the FPCB 630, and the sensor pad 620 may be disposed between the plurality of antenna elements 610 and may be segmented with a plurality of antenna elements 610 with the boundary of the insulating surface 615.

The plurality of antenna elements 610 may transmit and receive communication signals. The plurality of antenna elements 610 may be implemented as a plurality of conductive patches formed on one surface of the FPCB 630. Alternatively, the plurality of antenna elements 610 may be disposed inside the FPCB 630, and at least a portion of the antenna elements 610 may be exposed to one surface of the FPCB 630. The plurality of antenna elements 610 may be connected to the wireless communication module through a feeder.

The sensor pad 620 may be an electrode pad of a grip sensor of which capacitance varies by the approach or contact of an external object, and according to an embodiment, the sensor pad 620 may be implemented as a conductive pad independent of the plurality of antenna elements 610. Alternatively, the sensor pad 620 may be composed of a single body with a plurality of antenna elements 610, and may be electrically segmented by an insulating surface 615. The sensor pad 620 may be connected to the grip sensor through a feeder.

The sensor pad 620 may be disposed in the second region 602 that is curved in the direction of the display panel. In this example, the sensor pad 620 may have a structure where at least a portion is curved along one surface of the second region 602, and may sense approach or contact of an external object in the rear and lateral directions of the electronic device.

The sensor pad 620 may have a structure in which each side surface of each of the plurality of antenna elements 610 is surrounded. For example, at least one antenna element 610 may be disposed in the second region 602, and the sensor pad 620 may have a structure surrounding the outer surface of one antenna element 610. By the various arrangement structures of the sensor pad and the antenna element 610, the sensor pad 620 may reduce the influence of the antenna gain of the plurality of antenna elements 610 and may satisfy the minimum arrangement space for implementing the sensing function of the sensor pad 620.

The second antenna array 600 may transmit and receive the wireless communication signal together with the display antenna layer or may perform the function of the grip sensor, and the processor may likewise adjust the transmission energy of the second antenna array 600 according to the sensing result of the grip sensor.

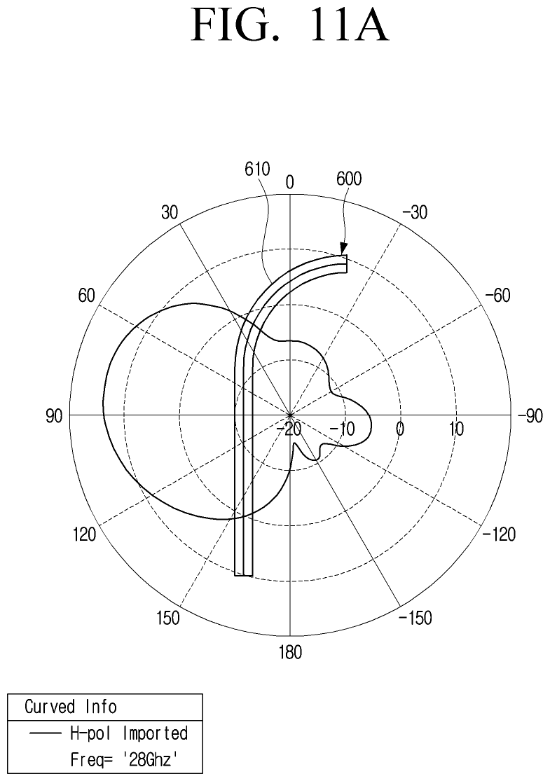

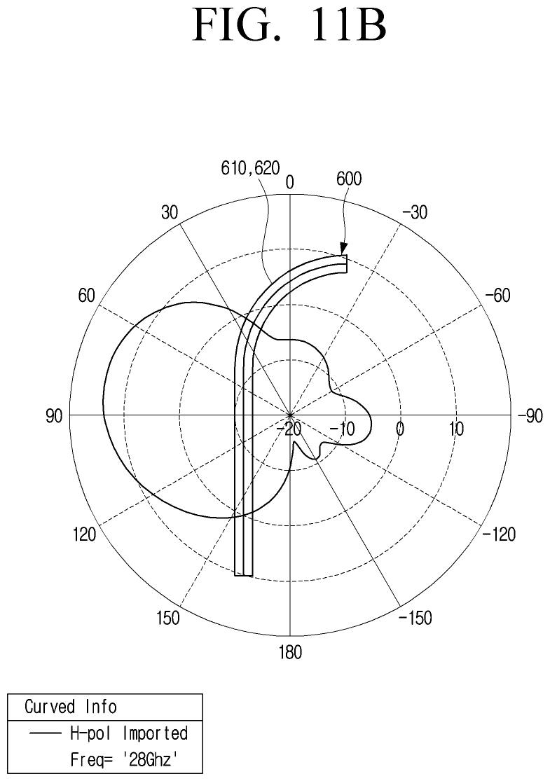

FIGS. 11A and 11B are graphs illustrating antenna gain according to a horizontal wave (H-pol) of a second antenna array according to embodiments.

Specifically, FIG. 11A illustrates an antenna gain in an example where the second antenna array includes a plurality of antenna elements, and does not include a sensor pad, and FIG. 11B illustrates an antenna gain in an example where the second antenna array includes a plurality of antenna elements and the sensor pad. In this case, the second antenna array may transmit or receive a wireless communication signal of high frequency in mmWave band.

Referring to the antenna gain of FIGS. 11A and 11B, it is shown that FIG. 11B, including the sensor pad, has no substantial difference in terms of antenna gain in comparison with the embodiment of FIG. 11A, which does not include the sensor pad. More specifically, according to the experimental result, the antenna gain of the second antenna array, which does not include the sensor pad, was measured to be about 13.85 bBI, and the antenna gain of the second antenna array including the sensor pad was measured to be about 13.73 bBI, Accordingly, the second antenna array may overcome antenna distortion by the shape and attachment structure of the sensor pad.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. An electronic device, comprising:
a housing including a front surface on which a display glass is formed;
a display panel;
a display antenna layer, provided inside the housing, between the display glass and the display panel, and configured to transmit and receive a communication signal;
a wireless communication module electrically connected to the display antenna layer;
a grip sensor configured to detect a change in capacitance of the display antenna layer based on an approach of an external object; and
a processor configured to receive a signal from the grip sensor and adjust a transmission energy of the display antenna layer, based on the received signal from the grip sensor.

2. The electronic device of claim 1, wherein the display antenna layer is provided in a direction parallel with the display panel, and
wherein the display antenna layer comprises a radial pattern in a mesh shape in which at least a portion is opened.

3. The electronic device of claim 2, wherein the display antenna layer further comprises:
a filler of which at least a portion is transparent, and
a transparent film through which a display screen of the display panel is visible.

4. The electronic device of claim 1, wherein the display antenna layer comprises:
a first antenna array, electrically connected with the wireless communication module, the first antenna array including a first conductive region for transmitting and receiving the communication signal;
a grip sensor pad, electrically connected with the grip sensor, the grip sensor pad including a second conductive region in which the capacitance is changed based on the approach of the external object; and
a segmental portion configured to electrically segment the first conductive region or the second conductive region from another region.

5. The electronic device of claim 4, wherein the first antenna array and the grip sensor pad are disposed to be adjacent to a side surface of the display antenna layer.

6. The electronic device of claim 5, wherein the first antenna array is in plural and performs multiple-input multiple output of the communication signal, and
wherein a plurality of first antenna arrays and the grip sensor pad are arranged to be adjacent to the side surface of the display antenna layer.

7. The electronic device of claim 5, wherein the first antenna array is directly connected to the wireless communication module, and
wherein the grip sensor pad is connected to the grip sensor.

8. The electronic device of claim 5, wherein the grip sensor pad detects a radiation pattern of the display antenna layer.

9. The electronic device of claim 1, further comprising a second antenna array, disposed at a rear surface of the display panel,
wherein the wireless communication module is electrically connected to the second antenna array and transmits and receives the communication signal, and
wherein the grip sensor detects a change in capacitance of the second antenna array based on approach of the external object.

10. The electronic device of claim 9, wherein the second antenna array comprises a flexible printed circuit board (FPCB) including a first region parallel to the display panel and a second region of which at least a portion is curved, extending in a first direction different from a second direction of a radiation pattern of the display antenna layer from the first region.

11. The electronic device of claim 10, wherein the second antenna array is disposed between the processor and a rear surface of the housing, and
wherein the second region of the second antenna array is positioned adjacent to a side surface of the housing.

12. The electronic device of claim 9, wherein the second antenna array comprises:
a plurality of antenna elements that are disposed to be apart from each other; and
a sensor pad, disposed between the plurality of antenna elements, of which capacitance is changeable based on the approach of the external object.

13. The electronic device of claim 12, wherein the second antenna array comprises a flexible printed circuit board (FPCB) of which at least a portion is curved in a first direction different from a second direction of a radiation pattern of the display antenna, and
wherein the sensor pad, which is disposed at a curved region of the FPCB, senses a rear direction and a lateral direction of the electronic device.

14. The electronic device of claim 12, wherein the sensor pad is in plural, and
wherein a plurality of sensor pads are disposed to surround side surfaces of each of the plurality of antenna elements.
